(19) United States
(12) Patent Application Publication
(10) Pub. No.: US 2001/0056470 A1
(43) Pub. Date: Dec. 27, 2001

(54) Electronic mail transmission/reception system and devices therefor

(76) Inventor: Takashi Ishitani, Habikino-shi (JP)

Correspondence Address: Dike, Bronstein, Roberts & Cushman, LLP, 130 Water Street, Boston, MA, 02019, US

(21) Appl. No.: 09/885,610

(22) Filed: Jun. 20, 2001

(30) Foreign Application Priority Data
Jun. 20, 2000 (JP) 2000-184712

(51) Int. Cl. G06F 15/16

(52) U.S. Cl. 709/206

(57) ABSTRACT

In an e-mail creating/sending device, an ID corresponding to attached data representing image or voice/sound included in multimedia data is generated. This multimedia data with attached data converted to the ID is sent to an e-mail receiving/reproducing device via a network. In this e-mail receiving/reproducing device, real data corresponding to the ID is generated and image or voice/sound represented by this real data is reproduced. The attached data, ID and real data are categorized and registered and an approximate ID or real data substitutes based on the category.

### BACKGROUND OF THE INVENTION

The present invention relates to an electronic mail transmission/reception system suitable to send and receive multimedia mails including attached data such as icon images, background images and voice, and various devices therefor, such as an electronic mail creating/sending device, an electronic mail receiving/reproducing device, an Internet access device, and recording media.

A multimedia mail including image, voice or the like has conventionally been transmitted/sent as electronic mail (e-mail). The method therefor has been any of the following methods.

(1) Method of Attaching Data Itself

The MIME (Multipurpose Internet Mail Extension) attachment method is provided for Internet mails and thereby a plurality of data with different formats can be transmitted. This is a method for sending real data itself representing image or voice to be sent as attached data in addition to a main body (text data) by using this mechanism.

(2) Method of Attaching Data Location (URL: Uniform Resource Locator)

This is an indirect transmission/reception method that does not attach real data to the main body text data, but once places the data to be sent on a server or the like from which a recipient can acquire data, and then specifies in the main body of an e-mail a method for accessing the data on the server (usually represented by an Internet URL in general) or attaches a URL.

When this method is employed, the recipient needs to receive a mail and then access a server or the like again to obtain the target attached data. However, by automatically doing this, some receiving devices (for example, mail software) allow a user to handle data as if the data itself had actually been sent. This applies to the HTML (HyperText Markup Language) text mail widely used recently.

(3) Method of Encoding Attached Data and Attaching in MIME Format (Japanese Patent Laid-Open Publication No. 10-260919)

In an e-mail terminal device, e-mail system and information processing system employing this method, when various data are encoded and attached in the MIME format, a helper program applicable to the attached data is specified to display and edit the attached data. Furthermore, when a helper program is not held in a device, a helper program is specified and shared on a network. Also, a method for storing and managing attached data of received data in relation to main body data can be efficiently managed in a receiving device.

The above-described conventional techniques have the following problems, respectively.

(1) Method of Attaching Data Itself

Although sent data can be reliably transmitted to the other party by this method, a problem arises that a size of mail data becomes very large. In particular, even when the attached data is data such as a decorative image, voice data or the like, which do not directly add any meaning to the main body text data, the data size becomes many times as large as text data. A very long server connection time for transmitting e-mail data and a huge capacity for storing the e-mail communications are thus required. In particular, frequent use of this method is not suitable for portable equipment having limited data transfer capacity and memory capacity.

(2) Method of Attaching Data Location (URL)

This method has the effect of preventing increase in mail data size as compared with the method of attaching data itself in (1). When one mail communication is to be read, there is no particular problem in accessing the attached data referred to by the URL in a LAN environment, where terminals are connected to a network at all times. However, a problem arises with portable equipment since the equipment needs to be connected to the network each time.

In general, even multimedia mails similarly including attached data have different attached data locations depending on the sender. Therefore, even when a method using a mechanism such as a cache for reducing access time is employed, the benefits can often not be obtained as a result.

(3) Method of Encoding Attached Data and Attaching in MIME Format (Japanese Patent Laid-Open Publication No. 10-260919)

This Japanese Patent Laid-Open Publication No. 10-260919 describes an efficient data managing method and a method of activating an applicable helper program as a method of managing received e-mails. In this method, however, data to be transmitted by e-mail still needs to be encoded before transmitted. Therefore, time required to transmit and receive data via a network cannot be reduced.

### SUMMARY OF THE INVENTION

Accordingly, an object of the present invention is to reduce time required to transmit/receive multimedia data including attached data such as image data, voice data or the like by reducing the size of data to be transmitted/received.

To achieve the above object, according to an aspect of the present invention, there is provided an electronic mail transmission/reception system for communicating data between an electronic mail creating/sending device and an electronic mail receiving/reproducing device via a network, wherein:

the electronic mail creating/sending device comprises:

an electronic mail creating means creating multimedia data including attached data representing an image, voice/sound, or the like; and

an ID (i.e., identifier) generating means generating an ID corresponding to the attached data such that the electronic mail creating/sending device sends the generated ID instead of the attached data, and

the electronic mail receiving/reproducing device comprises:

a real data generating means generating real data representing an image, voice/sound or the like corresponding to the ID such that the electronic mail receiving/reproducing device reproduces the image, voice/sound or the like represented by the real data.

With the above constitution, an ID corresponding to attached data representing image, voice or the like is generated by the ID generating means and the ID substituted for the attached data is sent to the e-mail receiving/reproducing device via a network. In this e-mail receiving/reproducing device, real data corresponding to the ID is generated by the real data generating means and image, voice or the like represented by this real data is reproduced.

Thus, actual attached data itself representing image, voice or the like is not sent, but an ID substituted for the attached data is sent. Therefore, the size of transmitted/received data can be reduced and thereby time required for transmission/reception can be shortened.

In one embodiment, the ID generating means generates an ID based on a category of attached data. Thus, even if an ID for a particular attached data itself is not held, the ID generating means generates an ID for an substitutive attached data having a meaning approximate to the meaning of the particular attached data. The ID of the substitutive attached data having an approximate meaning is sent, so that this approximate attached data can be substituted for the original attached data. As a result, the amount of storage of IDs and attached data associated with the respective IDs can be reduced. In particular, when voice data or image data, which is attached data, is standard-format sound data, icon image, or a background image which are used for decoration of e-mail or emotional expression, such attached data is easily and properly categorized. Therefore, appropriate attached data can be reproduced (converted to image, voice or the like) by the ID.

According to another aspect of the present invention, there is also provided an electronic mail transmission/reception system for communicating data between an electronic mail creating/sending device and an electronic mail receiving/reproducing device via a network, wherein:

said electronic mail creating/sending device comprises:

an electronic mail creating means creating multimedia data including attached data representing an image, voice/sound, or the like such that said electronic mail creating/sending device sends the multimedia data, and

a server connected to the network comprises an ID generating means generating an ID corresponding to attached data such that the server sends the ID instead of the attached data to said electronic mail receiving/reproducing device.

With the above constitution, the ID generating means of the server generates an ID corresponding to attached data. The ID substituted for the attached data is sent from the server to the e-mail receiving/reproducing device. Thus, since the attached data is converted to an ID by the relay server, e-mail data size on a path from the server to the e-mail receiving/reproducing device can be reduced, so that data transfer load can be relieved. This is useful, in particular, when a special device is not used as the e-mail creating/sending device or when the e-mail creating/sending device side has a thick pipe such as a high-speed LAN (Local Area Network) environment or the like, but the e-mail receiving/reproducing device is connected to a low-speed network as in the case of a mobile device.

Here, that the ID generating means generates an ID corresponding to attached data means that an ID is generated for attached data in one to one correspondence and/or that an ID is generated for substitutive attached data having the same or approximate meaning as the object attached data based on the category to which the attached data is classified according to its meaning.

In one embodiment, the server connected to the network comprises a real data generating means generating real data representing an image, voice/sound or the like corresponding to the ID such that the server sends the real data instead of the ID to said electronic mail receiving/reproducing device.

In this embodiment, the server receives an ID from the e-mail creating/sending device, converts this ID to real data and sends the data to the e-mail receiving/reproducing device. Therefore, the amount of data sent between the e-mail creating/sending device and the server can be reduced. Furthermore, even if the e-mail receiving/reproducing device is not provided with real data generating means, real data corresponding to attached data can be reproduced.

Here, that the real data generating means generates real data corresponding to an ID means that attached data itself is generated as real data based on the ID and/or that approximate data of the attached data which belongs to the same category as the attached data is generated as real data.

According to another aspect of the present invention, there is provided an electronic mail transmission/reception system for communicating data between an electronic mail creating/sending device and an electronic mail receiving/reproducing device via a network, wherein:

said electronic mail creating/sending device

an electronic mail creating means creating multimedia data including attached data representing an image, voice/sound, or the like; and

an ID generating means generating an ID corresponding to the attached data such that said electronic mail creating/sending device sends the generated ID instead of the attached data, and

a server connected to the network comprises:

a real data generating means generating real data representing an image, voice/sound or the like corresponding to the ID such that the server sends the real data instead of the ID to said electronic mail receiving/reproducing device, and

the electronic mail receiving/reproducing device reproduces the image, voice/sound or the like represented by the real data.

With the arrangement, the server receives an ID from the e-mail creating/sending device, converts this ID to real data and sends the data to the e-mail receiving/reproducing device. Therefore, the amount of data transmission between the e-mail creating/sending device and the server can be reduced. Furthermore, even if the e-mail receiving/reproducing device is not provided with a real data generating means, real data corresponding to attached data can be reproduced.

The real data may be identical to the attached data. Otherwise, the real data may be data belonging to the same category as the attached data and representing a content approximate to a content of the attached data.

In one embodiment, the e-mail creating/sending device has an ID acquiring means which, when its own ID generating means fails to generate an ID corresponding to attached data, inquires of the server about an ID corresponding to the attached data to acquire the corresponding to the attached data from the server. The e-mail creating/sending device sends the ID acquired from the server instead of the attached data.

In the above embodiment, because the e-mail creating/sending device obtains an ID corresponding to the attached data from the server by the ID acquiring means, the amount of IDs and attached data to be held in a storage unit of the e-mail creating/sending device can be reduced.

In one embodiment, the e-mail creating/sending device has a data/ID acquiring means which, when there is a request for attached data other than attached data corresponding to an ID which can be generated by the ID generating means of the e-mail creating/sending device, acquires such attached data and an ID corresponding to the attached data from the server.

In this embodiment, a plurality of e-mail creating/sending devices can share IDs and their associated attached data on the server. Therefore, the amount of IDs and attached data to be held by each e-mail creating/sending device can be reduced.

In one embodiment, the e-mail receiving/reproducing device has a real data acquiring means which, when the real data generating means of the e-mail receiving/reproducing device fails to generate real data corresponding to an ID, inquires of the server about real data corresponding to the ID to acquire the real data corresponding to the ID from the server. Then, the e-mail receiving/reproducing device reproduces the real data acquired from the server.

In the above embodiment, even if real data corresponding to a received ID is not held in the e-mail receiving/reproducing device, real data corresponding to the received ID is acquired from the server on the network by the aid of the real data acquiring means automatically or by instructions from a user. Thus, the real data can be reproduced in the e-mail receiving/reproducing device.

In one embodiment, the server sends the attached data, the ID, or another ID belonging to the same category as the ID to the e-mail receiving/reproducing device depending on ability of the e-mail receiving/reproducing device or at a request thereof.

For example, when an e-mail sending device is going to communicate the same multimedia e-mail to a plurality of counterpart terminals (e-mail receiving/reproducing devices), multimedia data to be sent inevitably needs to have contents suitable for an e-mail receiving/reproducing device having a lowest function. This means waste of costs in such e-mail receiving/reproducing devices as can reduce transmission costs by conversion of attached data to ID. On the other hand, if an ID is sent to an e-mail receiving/reproducing device which cannot reproduce real data corresponding to the ID, the recipient using this e-mail receiving/reproducing device will not able to reproduce the same information that other recipients obtain.

In contrast, in this embodiment, the server sends data in a sending format matching characteristics of each e-mail receiving/reproducing device depending on the ability or request of each e-mail receiving/reproducing device. Therefore, the e-mail creating/sending device is allowed to create data with desired contents without considering all the e-mail receiving/reproducing devices, so as to send the data at low sending costs.

In one embodiment, the ID is part of HTML e-mail. The ID can be identified by tags enclosing the ID at its front and back.

In this embodiment, since the ID is part of the HTML e-mail, even an e-mail receiving/reproducing device not compatible to the IDs can reproduce most parts of the e-mail. Thus, this e-mail transmission/reception system of the present invention can be utilized for general purposes in a very wide range.

In addition, since the ID is enclosed by tags at its front and back, the ID can be easily identified. Furthermore, icon image, sound or the like can be specified by attributes enclosed in the tags.

The ID can be expressed as, for example, URL in the HTML e-mail. In this case, even if such e-mail is received by an e-mail receiving/reproducing device which cannot interpret the ID, this received e-mail can be handled as a usual HTML e-mail expressed by URL and the e-mail can be reproduced (displayed or voice reproduced).

According to a further aspect of the present invention, there is provided an electronic mail creating/sending device for sending mail data via a network, comprising:

an electronic mail creating means creating multimedia data including attached data representing an image, voice/sound, or the like; and

an ID generating means generating an ID corresponding to the attached data such that the electronic mail creating/sending device sends the generated ID instead of the attached data.

Multimedia data can be easily created by the e-mail creating means by attaching data representing, for example, sound or icon images relatively frequently used to the main body data through select operation for example. An ID corresponding to attached data representing image, voice/sound or the like is generated by the ID generating means and the ID substituted for the attached data is sent via a network.

That is, the actual attached data representing image, voice/sound or the like is not sent, but the ID substituted for the attached data is sent. Therefore, the amount of sent data can be reduced and the time required to send the data can be shortened.

In one embodiment, the electronic mail creating/sending device has an ID registering means. This means store IDs and attached data corresponding to the IDs in categorized manner, and for a new attached data, identifies a category of the data, allocates an ID to the data and registers the data and the ID. Since new attached data are registered in association with respective IDs, the frequency of making an inquiry to the server can be reduced.

According to a still further aspect of the present invention, there is provided an electronic mail receiving/reproducing device for receiving via a network and reproducing multimedia data including an ID corresponding to attached data representing an image, voice/sound, or the like, comprising:

a real data generating means generating real data representing an image, voice/sound or the like corresponding to the ID included in the multimedia data such that said electronic mail receiving/reproducing device reproduces the image, voice/sound or the like represented by the real data.

With the above arrangement, since the ID sent instead of the attached data is received and then converted to real data, the amount of received data can be reduced and the time required to receive data can be shortened.

In one embodiment, the electronic mail receiving/reproducing device has a real data search means which, based on IDs and corresponding real data stored in categorized manner, searches for data belonging to a higher order category of a received ID or representative data if there is no real data corresponding to the received ID.

An electronic mail transmission/reception device according to an aspect of the present invention has the electronic mail creating/sending device of any type described above and the electronic mail receiving/reproducing device of any type described above.

This e-mail transmission/reception device has functions of both the e-mail creating/sending device and the e-mail receiving/reproducing device. Since the e-mail creating/sending device and the e-mail receiving/reproducing device are integrated, a new ID included in a received multimedia e-mail and attached data corresponding to the ID can be utilized on the e-mail creating/sending device side.

In one embodiment, the e-mail transmission/reception device has a recognizing means which, upon receiving multimedia data including an ID and attached data corresponding to the ID in a prescribed format, recognizes the ID and the attached data while associating them with each other. And the ID generating means is able to generate the ID associated with the attached data recognized by the recognizing means. Therefore, the amount of IDs and attached data to be held in the device can be increased based on the received data.

The present invention also provides an Internet access device comprising:

a real data generating means for generating real data representing image, voice/sound or the like corresponding to an ID representing attached data representing image, voice/sound or the like included in multimedia data;

a real data acquiring means for acquiring real data corresponding to the ID from a specific server or a server designated by a URL when the real data generating means cannot generate the real data corresponding to the ID; and

a reproducing means for reproducing the real data.

With the above arrangement, since real data is obtained from the received ID by the real data generating means, the amount of received data can be reduced and the time required to receive data can be shortened. Even if the real data generating means fails to generate real data corresponding to the ID, the real data corresponding to the ID can be acquired from a specific server or a server designated by URL by the real data acquiring means. Therefore, the amount of stored real data can be reduced.

It is to be emphasized that the present invention enables transmission/reception of increased data at reduced costs and time for a network by converting not only e-mail data but also any other types of communicable data to respective IDs.

Furthermore, the present invention provides recording media each containing a program for making a computer or computers function as the various means of the systems and the above-described devices according to the present invention.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of an electronic mail transmission/reception system according to one embodiment of the invention;

FIG. 2 is a hardware block diagram of an electronic mail transmission/reception device according to one embodiment of the invention;

FIG. 3 is a software block diagram of the electronic mail transmission/reception device of the above embodiment.

FIG. 4 is a flowchart showing a flow of e-mail creation;

FIG. 5 is a flowchart showing a subflow of e-mail creation;

FIG. 6 is a flowchart showing a subflow of attached data input;

FIG. 7 is a flowchart showing a flow of mail arrival;

FIG. 8 is a flowchart showing a flow of conversion of attached data to ID (encoding);

FIG. 9 is a flowchart showing a flow of interpretation (decoding) of attached data;

FIG. 10 is a flowchart showing a flow of server processing when e-mail is sent;

FIG. 11 is a flowchart showing a flow of server processing when e-mail is received;

FIG. 12 shows a constitution example of categorized IDs;

FIG. 13 is a flowchart showing a flow of registration of a categorized ID;

FIG. 14 is a flowchart showing a flow of search of a categorized ID; and

FIG. 15 shows an example of an HTML mail having attached data converted to an ID.

### DETAILED DESCRIPTION OF THE PREFERRED EMBODIMENTS

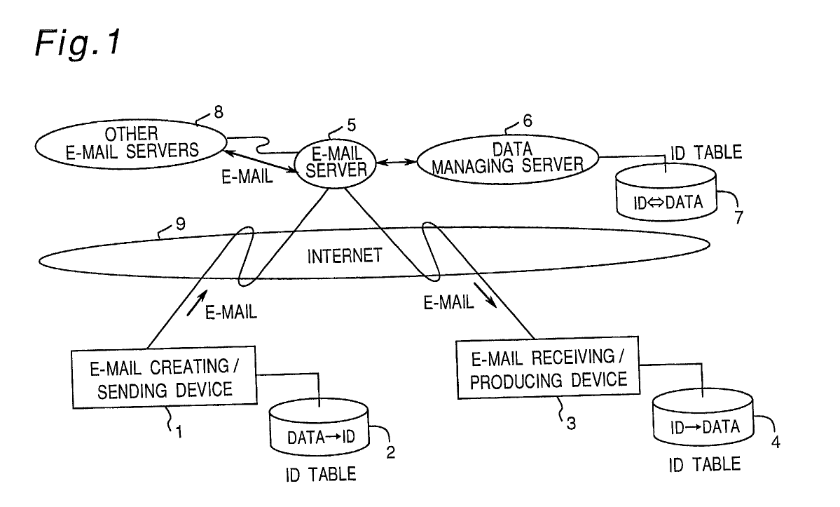

FIG. 1 shows configuration of the whole electronic mail (hereinafter referred to as ‘e-mail’) transmission/reception system of this embodiment. In this e-mail transmission/reception system, an e-mail creating/sending device 1 can create and send e-mail message and attached data. On the other hand, an e-mail receiving/reproducing device 3 can display and reproduce the sent e-mail message and attached data. The e-mail created and sent by the e-mail creating/sending device 1 is temporarily stored in an e-mail server 5. In an Internet mail system, the e-mail server 5 exists on the Internet 9 as shown in FIG. 1. In a local environment (so-called LAN: Local Area Network) or an environment other than the Internet, servers existing in each network environment have the same function as the e-mail server 5. Internet mails are usually transmitted from an e-mail server close to sending equipment, through various relay servers, to an e-mail server close to receiving equipment, which then hold the received mails. However, sending equipment and receiving equipment may transmit and receive data via the same e-mail server. Here, these cases are not particularly distinguished. To simplify the explanation, FIG. 1 shows a case where data is transmitted and received via the same e-mail server 5. E-mail data held by the e-mail server 5 is taken in by the e-mail receiving/reproducing device 3 by instruction from the e-mail receiving/reproducing device 3 or the like and is displayed to the user in a format suitable for the data. Each device is made of a computer.

FIG. 1 shows a case where data is transmitted via the e-mail server 5, but a system may be constituted such that the e-mail sending device 1 sends e-mail data or the like directly to the e-mail receiving device 3 via a network.

In this embodiment, the e-mail creating/sending device 1, e-mail receiving/reproducing device 3 and data managing server 6 existing on a network have ID tables 2, 4, 7, respectively, for enabling conversion between attached data and an ID (Identifier). Although not shown in FIG. 1, the e-mail server 5 itself may have an ID table.

In the e-mail creating/sending device 1, when a user selects data attached to e-mail created by the user, the ID table 2 belonging to the e-mail creating/sending device 1 is referenced to convert data to an ID. Data which can be converted to an ID is converted to an ID. Or, there can be provided a mechanism in which a list of data contained in the ID table 2 is displayed to the user when his or her e-mail is created so that the user can easily select data. Or, after the user presents data to be attached to the e-mail creating/sending device 1, whether this data can be converted to an ID is checked in this e-mail creating/sending device 1 by referencing the ID table 2, or, an ID corresponding to this data can be obtained by making an inquiry to the data managing server 6 and referencing the ID table 7 belonging to the data managing server 6. The e-mail data thus created is taken in the e-mail receiving/reproducing device 3 via the e-mail server 5 or the like.

In the e-mail receiving/reproducing device 3, when it is recognized that e-mail includes data converted to an ID, the ID table 4 in this e-mail receiving/reproducing device 3 is referenced in search of data corresponding to the ID. When data corresponding to this ID is found, the data substituted for the ID is displayed at a stage when the data needs to be displayed. If applicable data is not found, presentation of data corresponding to the ID can be requested of the data managing server 6 (or e-mail server 5).

The data managing server 6 (or e-mail server 5) has a function of responding to such an inquiry about the correspondence between ID and data, and updates data and provides a download service of a table defining correspondence between data and IDs.

In response to an inquiry about the correspondence between IDs and data from the e-mail receiving/reproducing device 3, the data managing server 6 (or e-mail server 5) references the ID table 7 in the server and searches for data corresponding to the ID. If the applicable data is found, the data is presented to the e-mail receiving/reproducing device 3. In response to this, the e-mail receiving/reproducing device 3 displays this data in the form of ID to thereby reproduce data as sent, and also registers this data in its own ID table 4 to thereby update information about correspondence between data and IDs.

The e-mail server 5 can relay or hold e-mail from other e-mail servers 8, in addition to e-mail from the e-mail creating/sending device 1 capable of sending IDs. At this time, when the e-mail server 5 relays or holds e-mail data, the e-mail server interprets the e-mail data and checks whether there is data which can be converted to an ID by searching the ID table 7 and further making an inquiry to the data managing server 6 when necessary. If data which can be converted to an ID is found, the data is converted to an ID. According to a request from the e-mail receiving/reproducing device 3, the e-mail is sent to the receiving/reproducing device 3 or relayed to another e-mail server.

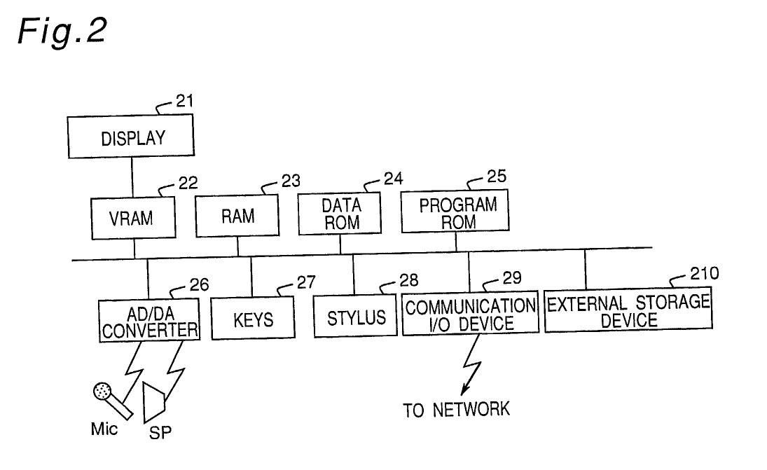

FIG. 2 shows a hardware configuration of the e-mail transmission/reception device. In the block diagram of the whole system in FIG. 1, the e-mail creating/sending device 1 and the e-mail receiving/reproducing device 3 are shown as separate equipment. However, either one device having a receiving function and a sending function or separate devices may be used. FIG. 2 shows an e-mail transmission/reception device having both a receiving function and a sending function as an example.

This e-mail transmission/reception device has a display 21 as reproducing means for displaying data, a VRAM (Video Random Access Memory) 22 for storing and sending display data to the display 21, a RAM (Random Access Memory) 23 to be used as a work storage unit for a program of processing e-mail data, a data ROM (Read Only Memory) 24 for holding fixed data and a program ROM 25 for holding an e-mail processing program. The e-mail transmission/reception device also has an AD (Analog to Digital)/DA (Digital to Analog) converter 26 for connecting a voice input/output device such as a microphone (Mic), a speaker (SP), which is reproducing means, or the like, keys 27 and a stylus or pen 28 for enabling user input, a communication I/O (input/output) device 29 for connecting to a network, and an external storage device 210 for holding e-mail data or the like. Among data for data/ID conversion, data which can be held as fixed data is written in advance and held in the data ROM 24. The updated data for data/ID conversion is held in the external storage device 210. The AD/DA converter 26 is used when sound data included in e-mail attached data is reproduced, or sound input data is attached, or the like. When an ID is converted to data and the data is sound data, the data is similarly outputted via the AD/DA converter 26. The keys 27 and the stylus 28 may be necessary or unnecessary depending on the type of the device and are not indispensable modules. In a device having the stylus 28, user input can be performed via the stylus 28. The stylus 28 can be used not only for character input, but also as user interface when data is selected. Servers are connected via the communication I/O device 29 when e-mail is sent or received.

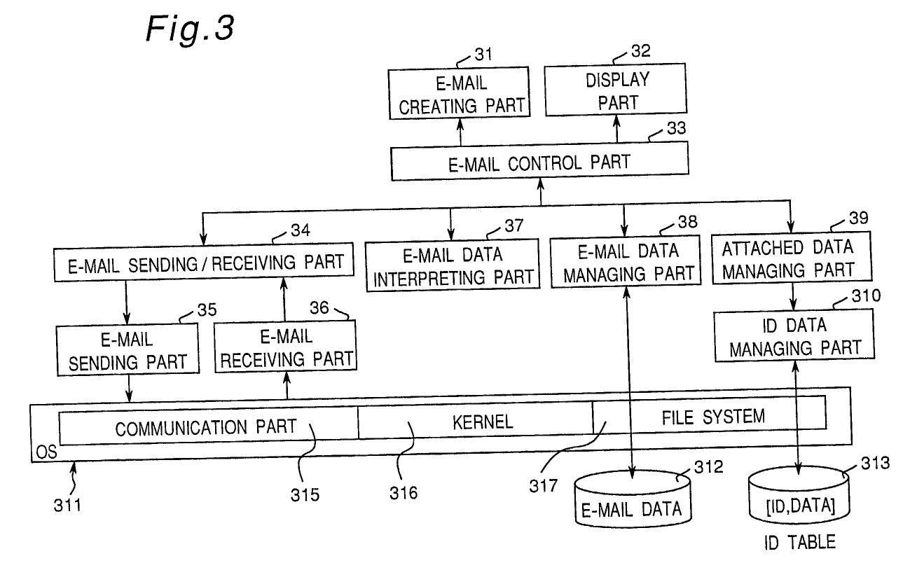

FIG. 3 shows an example of a software (program) configuration of the e-mail transmission/reception device.

When e-mail is created, e-mail data is created in an e-mail creating part 31. At this time, a user interface unit for interacting with a user, a function of referencing an address book for supporting destination input or the like may be used. However, since these detailed functions do not need to be distinguished here, description thereof is omitted. When creation of the e-mail is completed, this is notified to an e-mail control part 33. When this e-mail control part 33 determines that the e-mail data should be temporarily stored, interpretation required to manage the e-mail data is performed in an e-mail data interpreting part 37 and then the interpretation result is notified to an e-mail data managing part 38 while the e-mail data is stored in a storage unit (file) 312. At this time, when attached data exists in the created e-mail data, this is notified to an attached data managing part 39 as well.

The attached data managing part 39 analyzes attached data and references an ID table 313 via an ID data managing part 310 to know whether the attached data is registered data. If the attached data is registered data, the attached data is replaced with a corresponding ID, which is in turn stored. If the attached data is not registered data, the attached data is stored as it is.

Furthermore, if processing such as reference to data registered as IDs, insertion of attached data, or the like is necessary during creation of e-mail in the e-mail creating part 31, an inquiry may be made directly to the ID data managing part 310.

When e-mail is sent, the e-mail control part 33 sends to an e-mail sending/receiving part 34 the e-mail received from the e-mail creating part 31 or stored in the storage part 312.

The e-mail sending/receiving part 34 activates an e-mail sending part 35 to connect to an e-mail server by a function of a communication part 315 in the OS (Operating System) 311 and sends e-mail data in accordance with an e-mail sending protocol.

The OS 311 contains a function for controlling various application programs of the device, a function related to control of hardware and so forth. If divided roughly, the OS is constituted of a communication part 315, a kernel 316, a file system 317 as shown in FIG. 3. The communication part 315 controls communications, the kernel 316 controls operations of all software programs and the file system 317 controls file access.

When a communication device is activated, if required, telephone dialing operation or the like depending on equipment is performed in the communication part 315 in the OS 311. As an e-mail sending protocol for transmission to an e-mail server, a standard e-mail transfer protocol called SMTP (Simple Mail Transfer Protocol) is usually employed if the server to be connected to is an Internet server.

In receiving e-mail, the e-mail control part 33 receives an instruction to receive e-mail from a user or a schedule function set to regularly check e-mails, and instructs the e-mail sending/receiving part 34 to perform the e-mail receiving operation. The e-mail sending/receiving part 34 activates an e-mail receiving part 36, activates and connects the communication device provided by the OS 311 to an e-mail server and receives e-mail data in accordance with an e-mail receiving protocol. When the communication device is activated, if required, telephone dialing operation or the like depending on the equipment is also performed (the connection operation up to this dialing is the same procedure as sending). As a protocol for receiving e-mails from e-mail servers, a standard e-mail receiving protocol called POP (Post Office Protocol) 3 is usually employed when the device is connected to Internet servers.

The e-mail received from an e-mail server is sent from the e-mail receiving part 36 to an e-mail data interpreting part 37. The constitution of the e-mail such as header information, attached data information and the like is analyzed for each e-mail. Although a plurality of e-mail data may be received from an e-mail server with one connection operation, the e-mail control part 33 controls so that e-mail data received from the e-mail receiving part 36 are processed one by one. The header information of an e-mail communication includes not only information such as subject, destination, sender and the like, but also information about whether e-mail data is just text data or includes attached data. If the fact that e-mail data includes attached data is obtained from the header information, the type of the attached data, the number of the attached data, the format of the attached data and the like can be found by analyzing the e-mail data in further detail. These pieces of analytic information obtained by the e-mail data interpreting part 37 are transferred to an e-mail data managing part 38 and stored. The attached data is transferred to an attached data managing part 39. The attached data managing part 39 checks whether data represented by an ID exists among the attached data, and if there is, inquires of the ID data managing part 310 to convert the ID to real data. The ID data managing part 310 has an ID table 313 and has a function of responding to an inquiry about data corresponding to an ID or inquiry about ID corresponding to data.

The e-mail control part 33 can fetch necessary e-mail data from the storage part 312 and display the data as required. At this time, necessary data can be fetched from the e-mail data managing part 38 or the attached data managing part 39, transferred to the display part 32 and displayed.

When interpretation of attached data by the attached data managing part 39 indicates that there is data represented by an ID, but the data does not exist in the ID data managing part 310, data corresponding to the ID can be acquired by accessing a URL (Uniform Resource Locator) written in the e-mail data or accessing a predetermined server. In this case, the attached data managing part 39 connects to a target server by using a communication function provided by the communicating part 315 in the OS 311 and obtains desired data. The data thus acquired is registered in the ID table 313 in the device via the ID data managing part 310 such that the registered data can be used later. When data presented from the e-mail creating part 31 upon creation of an e-mail is not registered in the ID table 313, as required, data can be registered by connecting to a predetermined server and an ID can be acquired and registered in the ID table 313 of the own device via the ID data managing part 310.

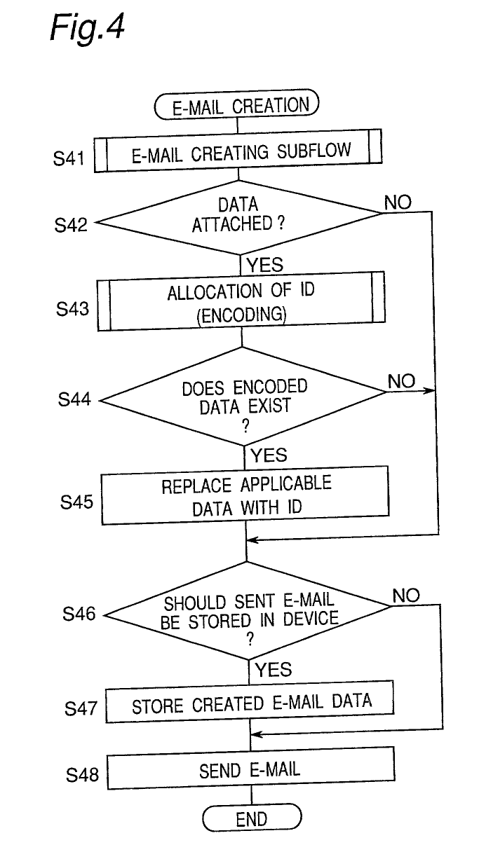

Flows of the above-described procedures will be described with reference to figures. An e-mail creation flow shown in FIG. 4 is a flow from e-mail creation to e-mail sending in the e-mail creating/sending device 1. The E-mail creation program is operated in the e-mail creating/sending device 1 shown in the system block diagram of FIG. 1. The flow in FIG. 4 is explained below with reference to portions of e-mail creation and e-mail sending in the software block diagram in FIG. 3.

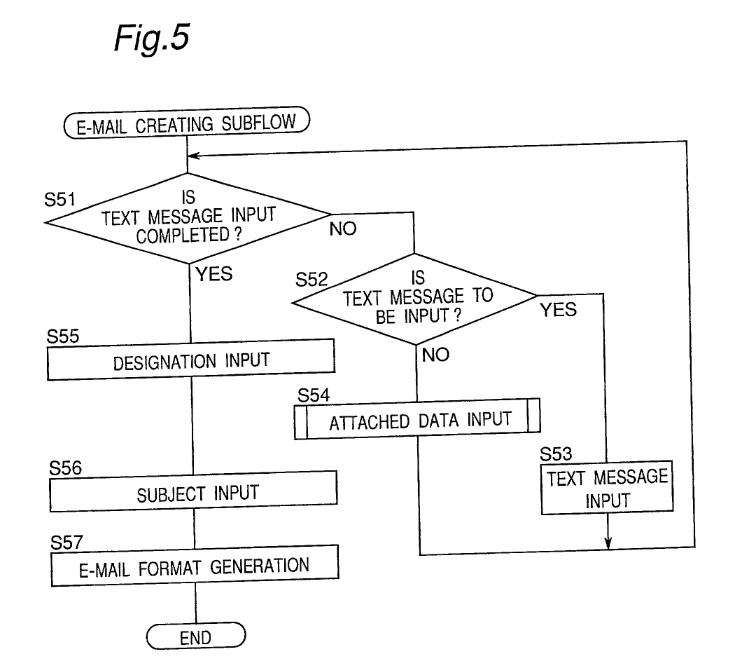

Step S41 is a procedure where e-mail creation is performed in the e-mail creating part 31 as e-mail creating means. This procedure is described in detail in an e-mail creating subflow in FIG. 5, described later, as a general procedure in the e-mail creation process. In step S42, whether attached data is included in the created e-mail is checked in the e-mail control part 33. If attached data is present, the program proceeds to step S43. If not, the processing proceeds to step S46.

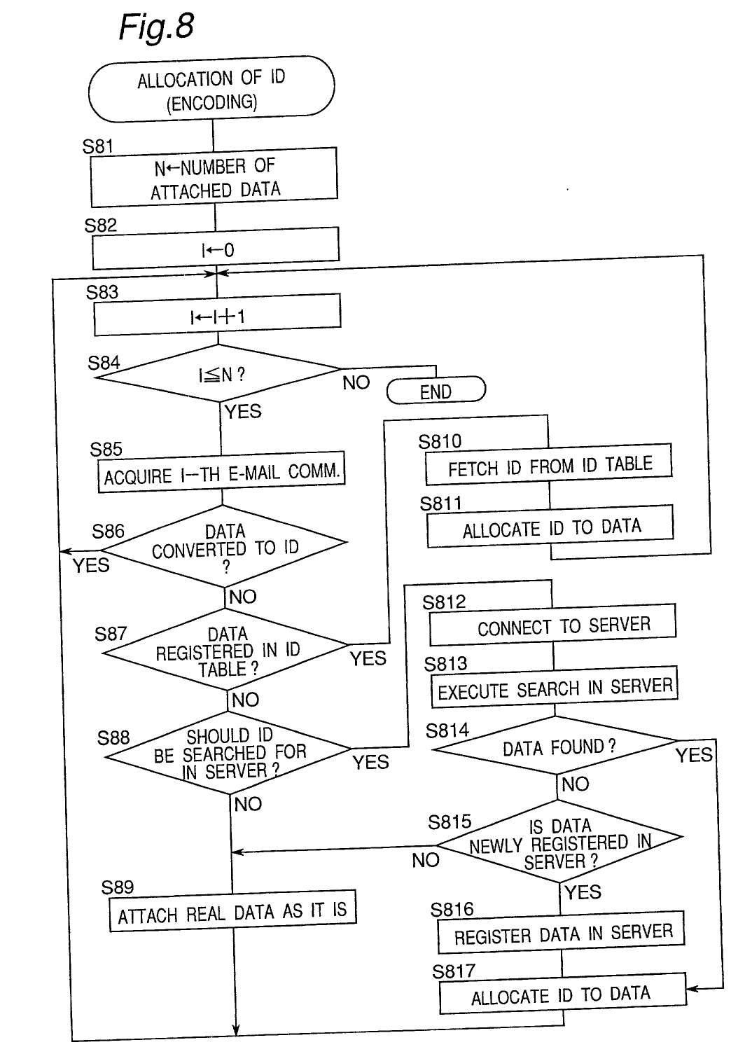

In step S43, the attached data managing part 39 inquires of the ID data managing part 310 about the found attached data to obtain an ID corresponding to the attached data and then allocates the ID to the attached data, namely, encodes the attached data. The details of the processing of allocation of ID (encoding) at this step S43 are shown in FIG. 8. In step S44, it is checked in the attached data managing part 39 whether attached data to which an ID was successfully allocated is present. In step S45, when such attached data is present, the attached data is actually replaced with the corresponding ID. The above steps S43 and S45 constitute an example of the ID generating means.

In step S46, an inquiry is made of the user or the like about whether e-mail to be sent is stored in the device as well. If the e-mail needs to be stored, the created e-mail data is stored in the storage unit (file) 312 through the e-mail data managing part 38 in step S47.

Finally, in step S48, the e-mail is sent by the e-mail sending/receiving part 34 and the e-mail sending part 35.

The e-mail creating procedure in step S41 of the e-mail creation flow in FIG. 4 is described in detail in the e-mail creating subflow in FIG. 5 and it is performed in the e-mail creating part 31.

In step S51, it is checked whether input of an e-mail message, or e-mail main body, is completed. If the input is not completed, the program proceeds to step S52. In step S52, it is discriminated whether a text message, which is a main body, is input or whether image, voice or the like, which is attached data, is input. In step S53, a main body is input. In step S54, attached data is input. To check whether there is other data to be added every time one input is performed in step S53 or step S54, the program goes back to step S51. If there is data to be added, the processing in steps S52, S53 and S54 is repeated. After it is confirmed that all inputs are completed in step S51, the processing proceeds to step S55.

In step S55, the destination of e-mail is inputted. In step S56, an appropriate subject is inputted as required. Thus, input of information required to create e-mail is completed. In step S57, e-mail data is generated in a mail format so that the e-mail can be sent. Thus creation of the e-mail is completed.

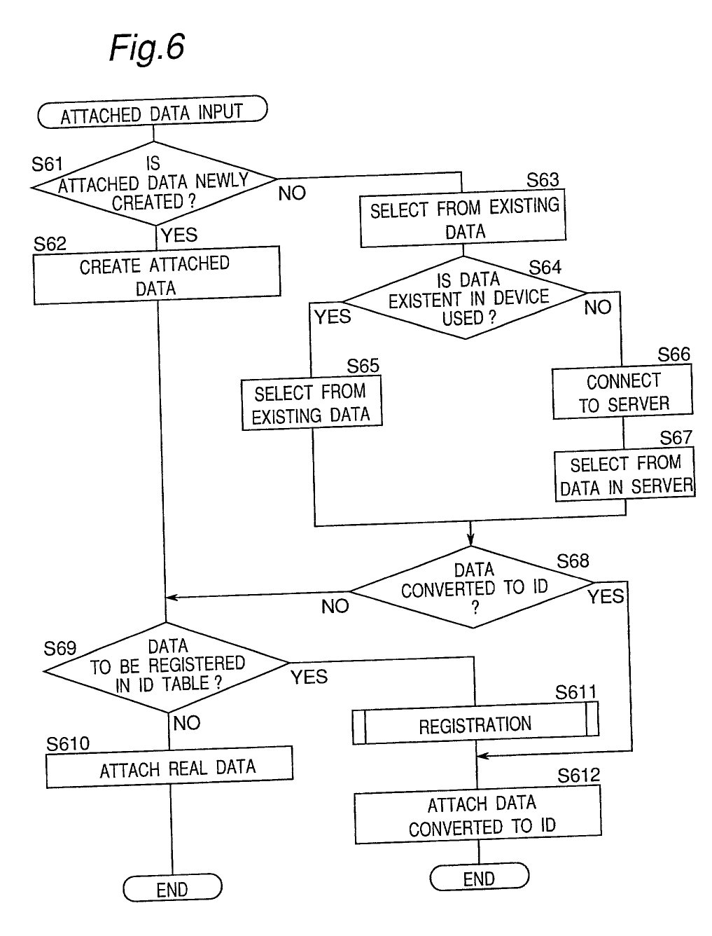

FIG. 6 shows a subflow of attached data input, which describes details of the procedure of attached data input in step S54 in the e-mail creating subflow in FIG. 5.

In step S61, it is discriminated whether attached data should be newly created. When attached data should be newly created, attached data is newly created in step S62. When attached data should be selected from existing data, selection is made from existing data in step S63. Usually, data is newly created by activating various application programs depending on the kind of data. On the other hand, existing data can be selected by selecting a position where the data is located. When existing data will be selected, it is further checked in step S64 whether the target data is existent in the device. If the target data exists in the device, it is selected from the existing data in the device in step S65. If the target data does not exist in the device, the device is connected to a server to select and download the data via a network in step S66. In step S67, the data is selected from existing data of the server.

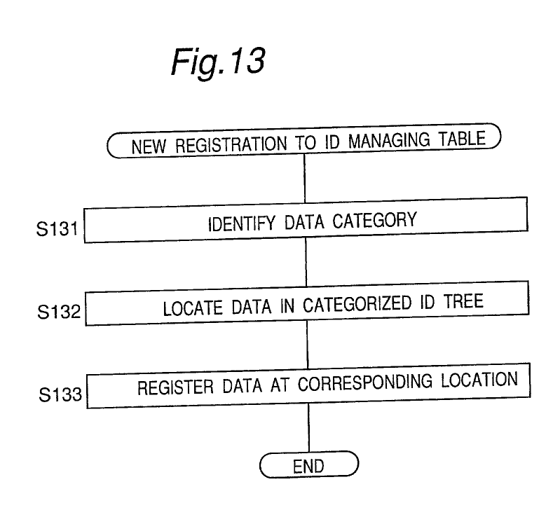

Subsequently, in step S68, it is checked whether the data selected in step S65 or step S67 has already been converted to an ID. If the data has not been converted to an ID, the program proceeds to step S69 and an inquiry is made to the user or a set value (e.g., of a flag) about whether the data is to be registered in the ID table 313. Similarly, an inquiry is made to the user or a set value (e.g., of a flag) about whether the data newly created in step S62 is to be registered in the ID table 313. If the data is to be registered, the data is registered in the ID table in step S611. If the data is not to be registered, the data itself, namely the real data, is attached in step S610. The step S611 constitutes an example of the ID registering means. The e-mail having attached data registered as it is in step S610 is handled as conventional-form e-mail. The registration processing in step S611 is applicable to a procedure of registering new data in the ID table 313 by the ID data managing part 310 in the software block diagram shown in FIG. 3. A specific flow as its example is a flow of registration of a categorized ID shown in FIG. 13. After the data has been registered in step S611, data converted to an ID is attached to the e-mail message in step S612. Thus, input of the attached data is completed. In this case, not the real data but the ID is attached as attached data.

FIG. 8 shows a flow of conversion of attached data to an ID (encoding). The procedure of conversion of attached data to an ID in step S43 in FIG. 4 is described in detail in this flow. This figure explains algorithm for converting data to an ID to be attached by selection or other process by the user. The process of conversion of attached data to an ID is carried out in the attached data managing part 39 shown in the software block diagram of FIG. 3.

First, in step S81, the number of attached data to be attached to e-mail is counted and the count is set to a temporary variable N. In step S82, a temporary variable I for counting the number of processed attached data is initialized to zero. A main loop for processing attached data one by one is constituted of step S83 and subsequent steps. In step S83, the temporary variable I is incremented by 1. In step S84, the temporary variable I and the total number of attached data N are compared. When all the data has been processed, the processing is terminated. If not, the I-th attached data is fetched in step S85. In step S86, it is checked whether the attached data has been converted to an ID. If the attached data has been converted to an ID, the data does not need to be converted. Therefore, the processing goes back to step S83 in the loop. If the attached data has not been converted to an ID, the processing proceeds to step S87.

In step S87, an inquiry about whether the attached data is registered in the ID table is made via the ID data managing part 310. If the attached data is registered, the ID corresponding to the data is fetched from the ID table 313 in step S810. In step S811 the ID is allocated to the attached data. Consequently, since the target attached data was replaced with the ID, the processing goes back to the main loop to process the next data.

If it is determined that the attached data is not registered in the ID table in step S87, the processing proceeds to step S88. In step S88, it is determined by making an inquiry to the user or the like whether it should be checked whether an applicable attached data is registered in the server. If the answer to the inquiry is no, this attached data cannot be converted to ID. Therefore, real data is attached as it is in step S89. If the answer is yes, the device is connected to the data managing server 6 to send the attached data in step S812. In step S813, the applicable data is searched for on the server. If it is found that the applicable data is registered in the server as a result of the search on the server in step S814, the ID is acquired from the server and allocated to the attached data in step S817. The steps S813 and S817 constitute an example of the ID acquiring means or data/ID acquiring means. If the applicable data is not registered, it is determined in step S815 whether the attached data is to be newly registered in the server. If the data is not to be registered, real data is attached as it is in step S89. If the data is to be registered, the data is registered in the server in step S816 and the new ID is issued in the server. In step S817, the ID is allocated to the data. The processing shown in FIG. 13 is an example of the processing of registration of data in the server in step S816. FIG. 13 shows a flow of registration of a categorized ID.

FIG. 6 shows a process in which the user attaches data converted to an ID in the e-mail creating scene. The figure indicates that the user can select or add attached data in interactive processing in advance of steps S811 and S817 in FIG. 8 where IDs are allocated to real data (encoding). In a procedure of attaching data as shown in FIG. 6, the algorithm of conversion to an ID can be applied to images and other various data created by the user as attached files. However, in general, such data can rarely be converted to an ID. Conversion to ID is particularly effective when atmos (sound icon), background image, image icon or the like used to modify e-mail message is attached. Such data may not frequently be attached by the user with much effort. However, if equipment having a user interface for easy selection and modification is used, nuance of the contents which cannot be expressed by a text alone can be transferred easily. This is very useful to the users. In spite of easy data selection due to such a user interface, such data may be hard to use if the amount of data in transmission is increased and the connection time is increased, resulting in increased costs. However, when the data is converted to an ID, a factor for increasing costs can be eliminated.

An e-mail receiving procedure in the e-mail receiving/reproducing device 3 will be described below.

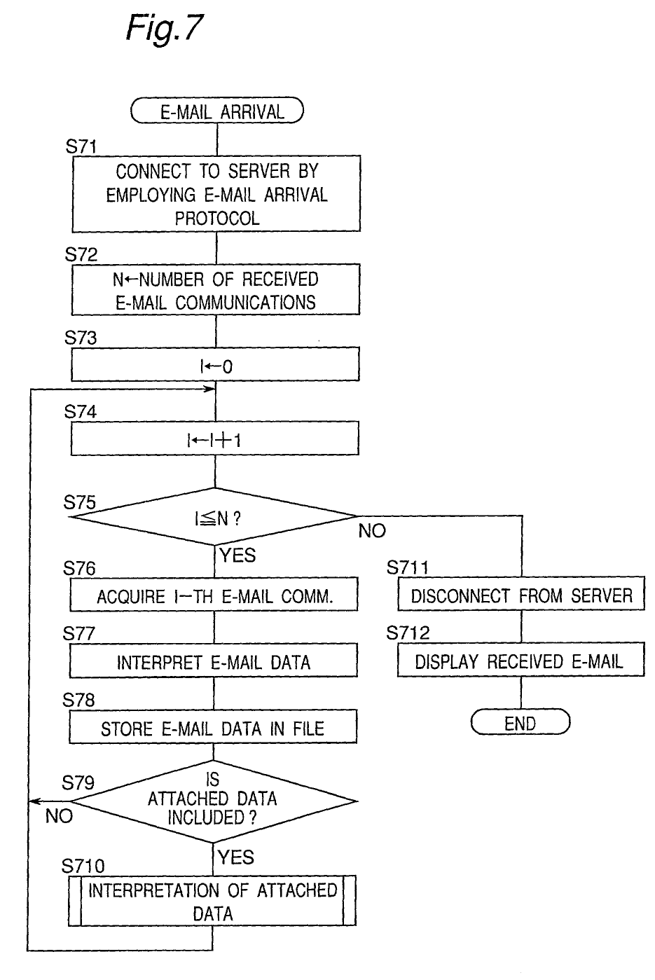

FIG. 7 shows an e-mail arrival flow and shows how e-mail communications received from the server are processed one by one. This processing is performed in the e-mail receiving part 36 in response to instructions from the e-mail sending/receiving part 34 shown in the software block diagram of FIG. 3.

In step S71, connection to the server is performed by using an e-mail arrival protocol. When e-mail arrives via the Internet, usually, an e-mail arrival protocol such as POP 3, IMAP (Internet Message Access Protocol) 4 or the like is often employed. These protocols are selected when they are supported both in the communicating part 315 in the OS 311 and in the server. In step S72, the number N of e-mail communications received from the server is acquired. In step S73, a variable I for counting the number of processed e-mail communications is initialized to zero.

Steps S74 to S710 constitute a main loop for processing e-mail communications one by one. In step S74, the number I of processed e-mail communications is incremented by 1. In step S75, the number I of processed e-mail communications and the total number N of received e-mail communications are compared. When all the e-mail communications have been processed, disconnection from the server is carried out in step S711. In step S712, the first data of the received e-mail is displayed. This display processing is performed by the e-mail display part 32 by request of the e-mail control part 33.

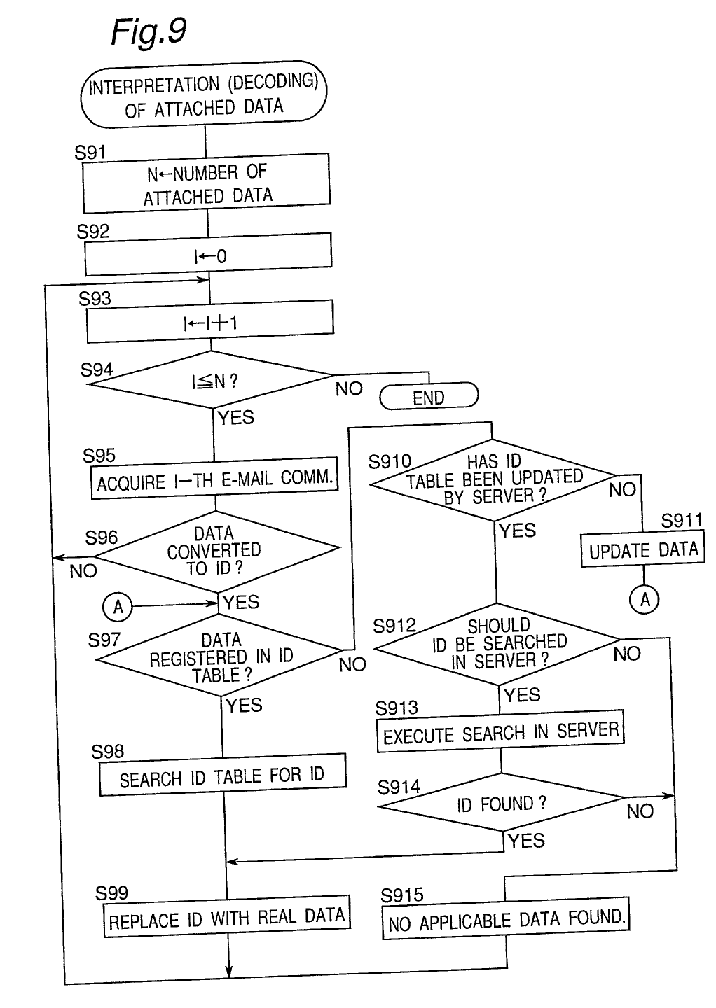

If there remain e-mail communications to be processed in step S75, the I-th e-mail communication is acquired from the server in step S76. In step S77, the e-mail data is interpreted in the e-mail data interpreting part 37 to find what kind of data constitutes the e-mail data, and the data is changed to an appropriate format. Then, in step S78, the data is stored as e-mail data in the storage part 312 by the e-mail data managing part 38. In step S79, whether attached data is included in the e-mail data is judged from the result of interpretation of the e-mail data. If attached data is present, the attached data is interpreted in step S710. If attached data is not present, the processing goes back to step S74 and processing of the next e-mail communication is carried out. Interpretation of attached data in step S710 is performed in a flow of interpretation (decoding) of attached data of which the details are shown in FIG. 9.

The flow of interpretation (decoding) of attached data in FIG. 9 is a procedure for interpreting data converted to an ID included in the received e-mail and replacing the ID with real data and is performed in the attached data managing part 39.

In step S91, the number of attached data is acquired and the number is stored in a temporary variable N. In step S92, a variable I for counting the number of processed attached data is cleared to zero. In step S93, the number I of processed data is incremented by 1. In step S94, the number I of processed data and the total number N of attached data are compared. If all the data have been processed, the processing is completed. If there is attached data to be processed, the I-th attached data is acquired in step S95. In step S96, it is judged whether the data has been converted to an ID. If the attached data has not been converted to an ID, the processing goes back to the first step S93 of the main loop to process the next data since decoding of the current data is not needed. If the attached data has been converted to an ID, the processing proceeds to step S97 to inquire of the ID data managing part 310 about whether the ID is already registered in the ID table 313 of the device. If the ID is already registered, the ID table 313 is searched for the ID and the applicable data is fetched in step S98. In step S99, the ID is replaced with real data. The steps S98 and S99 constitute an example of the real data generating means.

If the ID is not registered in the ID table in step S97, it is checked in step S910 whether the ID table 313 stored in the device is the latest one, namely, up to date. If updating of the ID table 313 is needed, information about the ID table is fetched from the server or the like, and data registered in the ID table 313 is updated in step S911. Then, in step S97, search is performed again.

When it is determined that the ID table 313 has already been updated in step S910, the processing proceeds to step S912 and it is determined whether to perform search in the server. This is because the server may have data in a wider range or data registered by other equipment or other users. When it is determined that an ID is searched for in the server in step S912, search of the ID is carried out in the server in step S913. In step S914, it is judged whether the ID has been found. If the ID has been found, the ID is replaced with corresponding real data in step S99 as in the case where the ID was found in the device. The steps S913 and S99 constitute an example of the real data acquiring means. The step S99 constitutes an example of the real data searching means. If the ID has not been found, the ID is left as it is in step S915 and the processing of the next data is performed. Data corresponding to an ID is not found when, for example, the sender converts attached data newly created in his or her own device to an ID but does not register the ID in the server. However, a sending device should preferably be configured or programmed such that when new data is registered in the device, registration to the server is automatically performed at the same time when e-mail is sent.

Real data thus substituted for the ID is not necessarily the same as originally sent data. However, it is noted that the ID is replaced at least with the data “belonging to the same category”, that is, “very similar” data. Consequently, if data which has arrived is regarded as same as data which arrived before and for which real data was received from the server, it is not necessary to receive the real data from the server again. Therefore, time during which the device is kept connecting to a network to receive data and costs can be reduced.

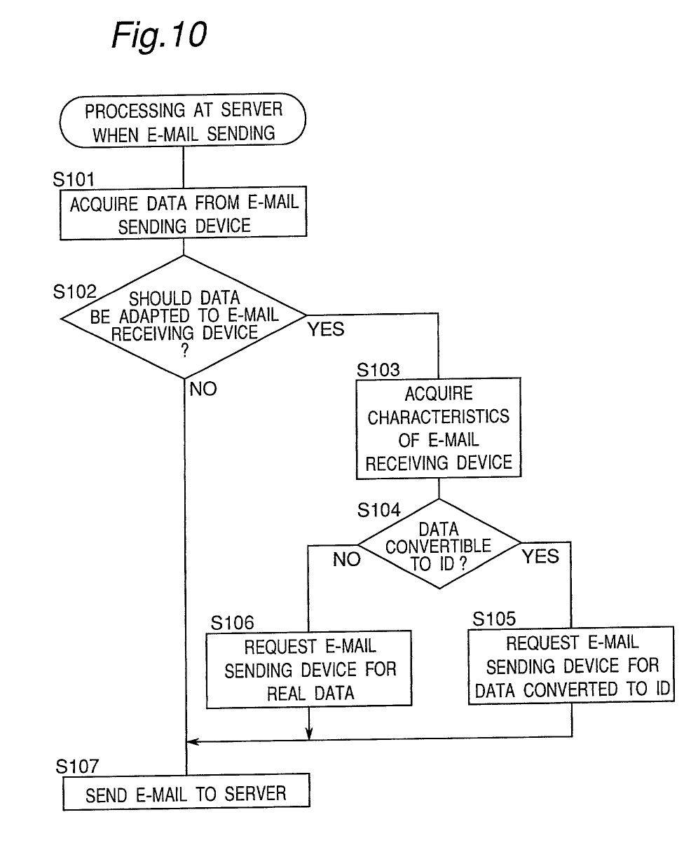

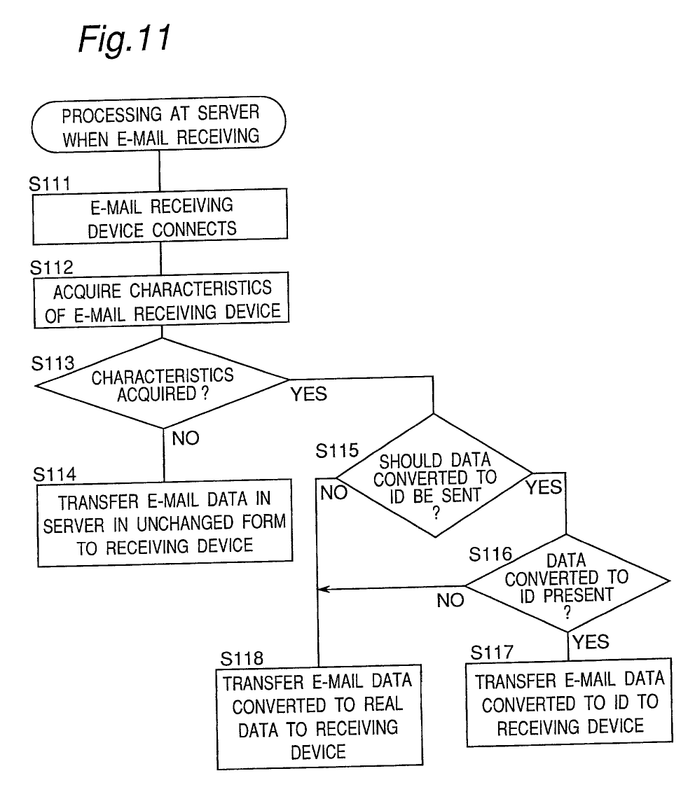

A flow shown in FIG. 10 of processing at a server when e-mail is sent and a flow shown in FIG. 11 of processing at a server when e-mail arrives show a procedure of transmission/reception of data converted to an ID at a server and a procedure of converting to an ID at the server during e-mail relay. Here, the procedures are characterized in that whether conversion to an ID is necessary is judged after judging the characteristics or properties of the e-mail receiving/reproducing device 3.

First, the flow of sending processing at server shown in FIG. 10 will be described below. In step S101, an e-mail massage including header is received from the e-mail creating/sending device 1. In step S102, it is determined whether the e-mail data should be changed to a format adapted to the characteristics of the e-mail receiving/reproducing device 3. This is determined based on information sent from the e-mail creating/sending device 1, instructions from the user, set values in the server 5 or 6, etc. If the e-mail format does not have to match the characteristics of the e-mail receiving/reproducing device 3, the e-mail is sent in the unchanged format in step S107. The sending processing performed at the server 5 in step S107 is as follows. If the e-mail receiving/reproducing device 3 will be connected to the server 5 as well, e-mail sent from the e-mail creating/sending device is stored in a temporary e-mail saving area in the same server 5 and connection from the e-mail receiving/reproducing device 3 is waited. If e-mail needs to be transferred to other servers, an ordinary e-mail transfer process is carried out.

When the e-mail format needs to match with the characteristics of the e-mail receiving/reproducing device 3, the characteristics of the e-mail receiving/reproducing device 3 are acquired in step S103. The characteristics of the e-mail receiving/reproducing device 3 are set in advance in the server 5 or 6, to which the e-mail receiving/reproducing device 3 is connected. For example, information such as whether e-mail data converted to ID should be received, what kind of attached data should be converted to an ID or the like, can be set. If different servers are used for e-mail sending and e-mail receiving, an inquiry about the characteristics of the e-mail receiving/reproducing device is made to the server in which the e-mail receiving/reproducing device is registered. In step S104, it is determined based on the inquiry result whether the data can be converted to an ID. If the data can be converted to an ID, a request to send data converted to the ID is issued to the e-mail creating/sending device 1 in step S105. On the other hand, if the data cannot be converted to an ID, a request to send real attached data (not converted data) is issued to the e-mail creating/sending device 1 in step S106. Then, the server 5 receives the e-mail data sent from the e-mail creating/sending device 1 in step S107.

A flow of server processing when e-mail arrives shown in FIG. 11 is described below.

In step S111, connection to the server 5 is carried out by the e-mail receiving/reproducing device 3. When connection between the e-mail receiving/reproducing device 3 and the server 5 is completed, the characteristics of the e-mail receiving/reproducing device 3 are acquired in step S112. This processing is the same as the processing in step S103 in FIG. 10. Subsequently, it is checked in step S113 whether the characteristics of the e-mail receiving/reproducing device 3 have been acquired. If the characteristics have not been acquired, e-mail data in the server 5 is transferred as it is to the e-mail receiving/reproducing device 3 in step S114. If the characteristics of the e-mail receiving/reproducing device 3 have been acquired and if data converted to an ID is included in the e-mail, then in step S115 it is judged from the characteristics of the e-mail receiving/reproducing device whether the data converted to an ID should be transferred as it is or whether the data converted to an ID should be returned to the original real data and then transferred to the e-mail receiving/reproducing device 3. If the data converted to an ID can be transferred, it is checked in step S116 whether data converted to an ID is present in the e-mail. If such data exists, e-mail data converted to an ID is transferred to the e-mail receiving/reproducing device 3 in step S117. If it is determined in step S115 that e-mail data converted to an ID is not transferred or it is determined in step S116 that data converted to an ID is not included in the e-mail, all IDs are converted to real data in the server 6 and the conversion results are transferred to the e-mail receiving/reproducing device in step S118. The conversion of data converted to ID back to real data is realized by performing almost the same processing as interpretation (decoding) of attached data shown in FIG. 9 in the server 6.

The procedure of converting to ID has been described only by using terms “convert” or “not convert”. However, IDs can be categorized such that particular data are substituted by representative data of the same category. Minute categorization can also be employed. The categorized ID can be applied in all the above-described conversions to ID and interpretation of data converted to ID.

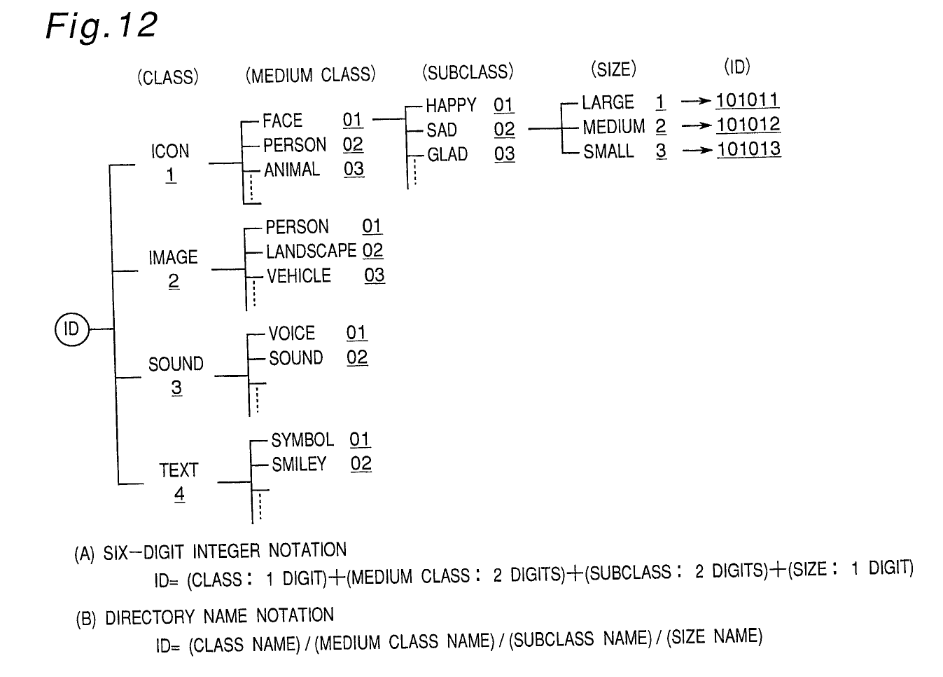

FIG. 12 shows a categorizing method for IDs and categorized IDs by way of example. In the example of FIG. 12, data are classified into four ranks of class, medium class, subclass, and size and constituted in a tree form. Then integers of one digit, two digits, two digits and one digit, respectively, are allocated to respective ranks and a totally 6-digit integer is generated as an ID (see notation (A) in FIG. 12). When this notation is utilized, if there is no applicable data in a certain rank, “0” or “00” are allocated to the data for the certain rank, and the data represented by the code including this value can be registered as representative data representing a category. When this method is utilized, data which presently is not detailed any further can be handled using the representative data.

In a similar category constitution, IDs can be represented by a character string like a directory constitution, instead of numerals (see notation (B) in FIG. 12). This notation is not different from the numerical notation in essence, but is different only in form. Of course, the latter ID notation (B) is much more extensible in categorization of IDs. That is, if the numerical format (A) is used, it is difficult to make the predetermined ranks (here, four ranks are represented by a six digit number) deeper, namely add deeper ranks, without reallocating IDs to all the data. On the other hand, in the directory path notation format (B), there is no such limitation and only specific IDs are allowed to be in deeper ranks.

A flow of registration of a categorized ID shown in FIG. 13 details a procedure of registering data into a tree of categorize IDs.

In step S131, the category of data is checked to identify which category in the held category tree the data belongs to. Subsequently, in step S132, the data is located in the currently registered ID table (categorized ID tree). If the same category is registered, the location of the data in the tree can be identified. If not, a location in a higher order category in the tree is determined as the location of the data. In step S133, the data is registered at the corresponding location in the tree and an ID is newly allocated. The steps S131 and S132 constitute an example of the recognizing means. The step S133 constitutes an example of the ID registering means.

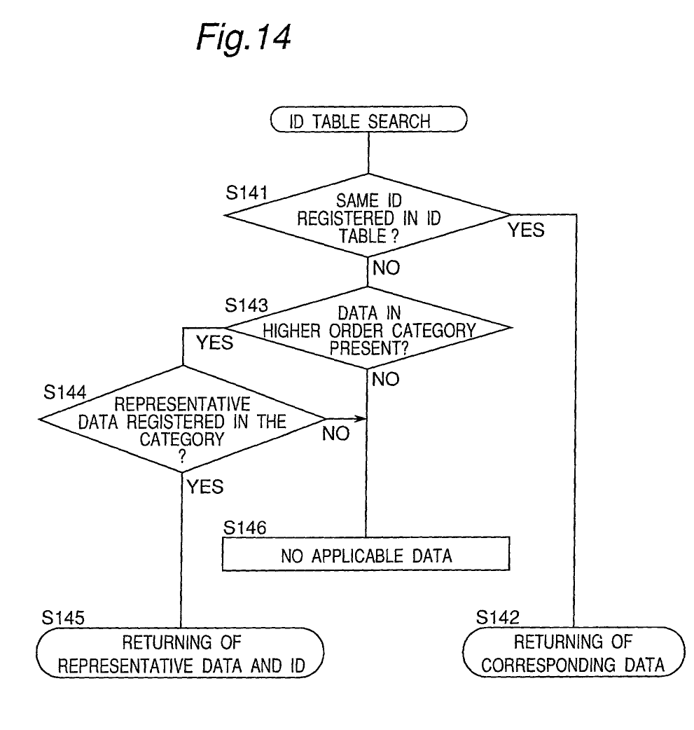

FIG. 14 shows a flow of searching for a categorized ID. FIG. 14 details a procedure of, by specifying an ID, searching the categorized ID tree (ID table) for data coincident with the specified ID or closest data.

In step S141, it is checked whether exactly the same value as the specified ID is registered in the ID table. If such a value is registered, the corresponding data is just returned in step S142. If exactly the same value as the specified ID is not registered, it is checked in step S143 whether data is registered which belongs to a higher order category than that of the data to be searched for. If data in a higher order category is registered, then it is further checked in step S144 whether representative data representing the category is registered in the category. The representative data is data having a meaning representing meanings of each individual data belonging to the same category. If such data is present, the representative data is returned to the device as an approximate data of the search target in step S145. When it is determined that data belonging to a higher order category is not present in step S143 or that a representative data is not registered in step S144, search is judged to be impossible and no applicable data is notified in step S146. If a representative data is not registered, then, alternatively, another data belonging to the same category may be returned. However, because there is usually a delicate difference and data which is not a representative data cannot necessarily substitute, the above processing shown in the figure has been described. But the present invention is not limited to the shown example.

As described above, in search of data, usually ID managed data (these are constituted in a categorized tree form) held in each terminal are first searched by the procedure in FIG. 14. If data is not found because the data is not registered or if data is found but only in a higher order category, then similar search is performed in the tree on the server according to the procedure of each device.

Since all data are usually registered on the server, the search result in the server should be accepted. However, as the configuration of this system is further developed, it can be expected that it becomes difficult to completely manage ID data by only one server. In such a case, data may be exchanged between servers or inter-sever data search service may be accepted. In such a case, the system may be constituted such that when search is performed in a server and data is not found in the server, a search is requested of another server and the result is returned.

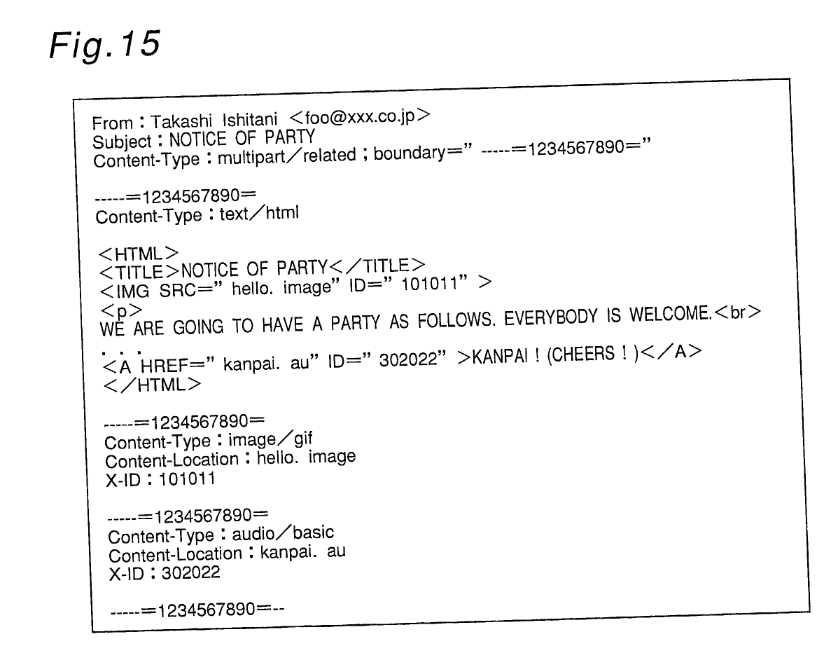

FIG. 15 shows an example of HTML e-mail having attached data converted to an ID. This e-mail is an example of e-mail data including a plurality of attached data separated by a character string, “- - - - - =1234567890=”. The message or main body is a portion starting with “Content-Type:text/html”. The message include a description, <IMG SRC=“hello.image”>. If such a description is included in a normal HTML-format e-mail, image data of “hello.image” needs to be attached or displayed by acquiring the data from the server. However, in this example, the attached data, Content-Location:hello.image” is shown, along with its ID described in next line as X-ID:101011. This indicates that the data has been converted to an ID. Therefore, the e-mail receiving/reproducing device 3 knows from such description that the data having ID 101011 needs to be retrieved and displayed. In this example, sound data is also converted to an ID and attached. Due to the presence of the description <A HREF=“kanpai.au”>, attached data, “Content-Location: kanpai.au”, is searched for. Since the ID is 302022, the data can be readily reproduced similarly.

As is evident from this example, the effects of the present invention are obtained particularly when icon image, sound data for modifying the e-mail message or the like are attached.

As described above, this embodiment has been described centering on image and voice/sound data. However, the present invention is not limited to these kinds of attached data, but is applicable to other kinds of data.

The above description is about the e-mail transmission/reception system, e-mail creating/sending device, e-mail receiving/reproducing device and e-mail transmission device. However, the present invention is not limited to e-mailing, but can be applicable to, for example, the Internet access.

The Internet access device in this embodiment includes real data generating means for generating real data representing image, voice/sound or the like corresponding to an ID representing attached data representing image, voice/sound or the like included in multimedia data, real data acquiring means for acquiring real data corresponding to the ID from a specific server or a server designated by a URL when the real data generating means cannot generate the real data corresponding to the ID, and reproducing means for reproducing the real data.

With the above constitution, since real data is obtained from the received ID by the real data generating means, the amount of received data can be reduced and the time required to receive data can be shortened. Even when the real data generating means cannot generate real data corresponding to an ID, real data corresponding to the ID can be acquired by the real data acquiring means from a specific server or a server designated by a URL. Therefore, the amount of stored real data can be reduced. Not only e-mail attached data but also various other communicable data may be converted to respective IDs to thereby reduce costs for network communications while increasing an amount of data exchange.

As is obvious from the above, according to the present invention, since actual attached data representing image, voice/sound or the like is not transmitted/received, but an ID corresponding to the attached data is transmitted/received, the size of transmitted/received data can be reduced and time required for transmission/reception can be shortened.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic mail transmission/reception system for communicating data between an electronic mail creating/sending device and an electronic mail receiving/reproducing device via a network, wherein:
said electronic mail creating/sending device comprises:
an electronic mail creating means creating multimedia data including attached data representing an image, voice/sound, or the like; and
an ID generating means generating an ID corresponding to the attached data such that said electronic mail creating/sending device sends the generated ID instead of the attached data, and
said electronic mail receiving/reproducing device comprises:
a real data generating means generating real data representing an image, voice/sound or the like corresponding to the ID such that said electronic mail receiving/reproducing device reproduces the image, voice/sound or the like represented by the real data.

2. The electronic mail transmission/reception system of claim 1, wherein the ID generating means generates an ID based on a category of attached data.

3. The electronic mail transmission/reception system of claim 1, wherein a server connected to the network comprises an ID generating means generating an ID corresponding to attached data such that the server sends the ID instead of the attached data to said electronic mail receiving/reproducing device.

4. The electronic mail transmission/reception system of claim 1, wherein the real data is identical to the attached data.

5. The electronic mail transmission/reception system of claim 1, wherein the real data is data belonging to the same category as the attached data and representing a content approximate to a content of the attached data.

6. The electronic mail transmission/reception system of claim 3, wherein the e-mail creating/sending device further comprises an ID acquiring means which, when its own ID generating means fails to generate an ID corresponding to attached data, inquires of the server about an ID corresponding to the attached data to acquire the ID corresponding to the attached data from the server such that the e-mail creating/sending device sends the ID acquired from the server instead of the attached data.

7. The electronic mail transmission/reception system of claim 3, wherein the e-mail creating/sending device has a data/ID acquiring means which, when there is a request for attached data other than attached data corresponding to an ID which can be generated by the ID generating means of the e-mail creating/sending device, acquires such attached data and the ID corresponding to the attached data from the server.

8. The electronic mail transmission/reception system of claim 3, wherein the e-mail receiving/reproducing device has a real data acquiring means which, when the real data generating means of the e-mail receiving/reproducing device fails to generate real data corresponding to an ID, inquires of the server about real data corresponding to the ID to acquire the real data corresponding to the ID from the server such that the e-mail receiving/reproducing device reproduces the real data acquired from the server.

9. The electronic mail transmission/reception system of claim 3, wherein the server sends the attached data, the ID, or another ID belonging to the same category as the ID to the e-mail receiving/reproducing device depending on ability of the e-mail receiving/reproducing device or at a request thereof.

10. The electronic mail transmission/reception system of claim 1, wherein the ID is part of HTML e-mail, and the ID can be identified by tags enclosing the ID at its front and back.

11. The electronic mail transmission/reception system of claim 10, wherein the ID is expressed as URL in the HTML e-mail.

12. An electronic mail transmission/reception system for communicating data between an electronic mail creating/sending device and an electronic mail receiving/reproducing device via a network, wherein:
said electronic mail creating/sending device comprises:
an electronic mail creating means creating multimedia data including attached data representing an image, voice/sound, or the like such that said electronic mail creating/sending device sends the multimedia data, and
a server connected to the network comprises an ID generating means generating an ID corresponding to attached data such that the server sends the ID instead of the attached data to said electronic mail receiving/reproducing device.

13. The electronic mail transmission/reception system of claim 12, wherein the server connected to the network comprises a real data generating means generating real data representing an image, voice/sound or the like corresponding to the ID such that the server sends the real data instead of the ID to said electronic mail receiving/reproducing device.

14. The electronic mail transmission/reception system of claim 12, wherein the real data is identical to the attached data.

15. The electronic mail transmission/reception system of claim 13, wherein the real data is data belonging to the same category as the attached data and representing a content approximate to a content of the attached data.

16. The electronic mail transmission/reception system of claim 13, wherein the e-mail creating/sending device further comprises an ID acquiring means which, when its own ID generating means fails to generate an ID corresponding to attached data, inquires of the server about an ID corresponding to the attached data to acquire the ID corresponding to the attached data from the server such that the e-mail creating/sending device sends the ID acquired from the server instead of the attached data.

17. The electronic mail transmission/reception system of claim 13, wherein the e-mail creating/sending device has a data/ID acquiring means which, when there is a request for attached data other than attached data corresponding to an ID which can be generated by the ID generating means of the e-mail creating/sending device, acquires such attached data and the ID corresponding to the attached data from the server.

18. The electronic mail transmission/reception system of claim 12, wherein the e-mail receiving/reproducing device has a real data acquiring means which, when the real data generating means of the e-mail receiving/reproducing device fails to generate real data corresponding to an ID, inquires of the server about real data corresponding to the ID to acquire the real data corresponding to the ID from the server such that the e-mail receiving/reproducing device reproduces the real data acquired from the server.

19. The electronic mail transmission/reception system of claim 12, wherein the server sends the attached data, the ID, or another ID belonging to the same category as the ID to the e-mail receiving/reproducing device depending on ability of the e-mail receiving/reproducing device or at a request thereof.

20. The electronic mail transmission/reception system of claim 12, wherein the ID is part of HTML e-mail, and the ID can be identified by tags enclosing the ID at its front and back.

21. The electronic mail transmission/reception system of claim 20, wherein the ID is expressed as URL in the HTML e-mail.

22. An electronic mail transmission/reception system for communicating data between an electronic mail creating/sending device and an electronic mail receiving/reproducing device via a network, wherein:
said electronic mail creating/sending device comprises:
an electronic mail creating means creating multimedia data including attached data representing an image, voice/sound, or the like; and
an ID generating means generating an ID corresponding to the attached data such that said electronic mail creating/sending device sends the generated ID instead of the attached data, and
a server connected to the network comprises:
a real data generating means generating real data representing an image, voice/sound or the like corresponding to the ID such that the server sends the real data instead of the ID to said electronic mail receiving/reproducing device, and
said electronic mail receiving/reproducing device reproduces the image, voice/sound or the like represented by the real data.

23. The electronic mail transmission/reception system of claim 22, wherein the real data is identical to the attached data.

24. The electronic mail transmission/reception system of claim 22, wherein the real data is data belonging to the same category as the attached data and representing a content approximate to a content of the attached data.

25. The electronic mail transmission/reception system of claim 22, wherein the e-mail creating/sending device further comprises an ID acquiring means which, when its own ID generating means fails to generate an ID corresponding to attached data, inquires of the server about an ID corresponding to the attached data to acquire the ID corresponding to the attached data from the server such that the e-mail creating/sending device sends the ID acquired from the server instead of the attached data.

26. The electronic mail transmission/reception system of claim 22, wherein the e-mail creating/sending device has a data/ID acquiring means which, when there is a request for attached data other than attached data corresponding to an ID which can be generated by the ID generating means of the e-mail creating/sending device, acquires such attached data and the ID corresponding to the attached data from the server.

27. The electronic mail transmission/reception system of claim 22, wherein the e-mail receiving/reproducing device has a real data acquiring means which, when the real data generating means of the e-mail receiving/reproducing device fails to generate real data corresponding to an ID, inquires of the server about real data corresponding to the ID to acquire the real data corresponding to the ID from the server such that the e-mail receiving/reproducing device reproduces the real data acquired from the server.

28. The electronic mail transmission/reception system of claim 22, wherein the server sends the attached data, the ID, or another ID belonging to the same category as the ID to the e-mail receiving/reproducing device depending on ability of the e-mail receiving/reproducing device or at a request thereof.

29. The electronic mail transmission/reception system of claim 22, wherein the ID is part of HTML e-mail, and the ID can be identified by tags enclosing the ID at its front and back.

30. The electronic mail transmission/reception system of claim 29, wherein the ID is expressed as URL in the HTML e-mail.

31. An electronic mail creating/sending device for sending mail data via a network, comprising
an electronic mail creating means creating multimedia data including attached data representing an image, voice/sound, or the like; and
an ID generating means generating an ID corresponding to the attached data such that the electronic mail creating/sending device sends the generated ID instead of the attached data.

32. The electronic mail creating/sending device of claim 31, wherein the ID generating means generates an ID based on a category of attached data.

33. The electronic mail creating/sending device of claim 31, further comprising an ID acquiring means which, when said ID generating means fails to generate an ID corresponding to attached data, inquires of a server connected to the network about an ID corresponding to the attached data to acquire the ID corresponding to the attached data from the server such that the e-mail creating/sending device sends the ID acquired from the server instead of the attached data.

34. The electronic mail creating/sending device of claim 31, further comprising a data/ID acquiring means which, when there is a request for attached data other than attached data corresponding to an ID which can be generated by the ID generating means, acquires such attached data and the ID corresponding to the attached data from a server connected to the network.

35. The electronic mail creating/sending device of claim 31, further comprising an ID registering means storing IDs and attached data corresponding to the IDs in categorized manner, and for a new attached data, identifying a category of the data, allocating an ID to the data and registering the data and the ID.

36. An electronic mail receiving/reproducing device for receiving via a network and reproducing multimedia data including an ID corresponding to attached data representing an image, voice/sound, or the like, comprising:
a real data generating means generating real data representing an image, voice/sound or the like corresponding to the ID included in the multimedia data such that said electronic mail receiving/reproducing device reproduces the image, voice/sound or the like represented by the real data.

37. The electronic mail receiving/reproducing device of claim 36, wherein the real data is identical to the attached data.

38. The electronic mail receiving/reproducing device of claim 36, wherein the real data is data belonging to the same category as the attached data and representing a content approximate to a content of the attached data.

39. The electronic mail receiving/reproducing device of claim 36, further comprising a real data acquiring means which, when the real data generating means fails to generate real data corresponding to an ID, inquires of a server connected to the network about real data corresponding to the ID to acquire the real data corresponding to the ID from the server such that the e-mail receiving/reproducing device reproduces the real data acquired from the server.

40. The electronic mail receiving/reproducing device of claim 36, further comprising a real data search means which, based on IDs and corresponding real data stored in categorized manner, searches for data belonging to a higher order category of a received ID or representative data if there is no real data corresponding to the received ID.

41. An electronic mail transmission/reception device for sending and receiving mail data via a network, comprising:
an electronic mail creating/sending device including:
an electronic mail creating means creating multimedia data including attached data representing an image, voice/sound, or the like; and
an ID generating means generating an ID corresponding to the attached data such that the electronic mail creating/sending device sends the generated ID instead of the attached data, and
an electronic mail receiving/reproducing device receiving and reproducing multimedia data including an ID corresponding to attached data representing an image, voice/sound, or the like, comprising:
a real data generating means generating real data representing an image, voice/sound or the like corresponding to an ID included in the multimedia data such that the electronic mail receiving/reproducing device reproduces the image, voice/sound or the like represented by the real data.

42. The electronic mail transmission/reception device of 41, comprising:
a recognizing means which, upon receiving multimedia data including an ID and attached data corresponding to the ID in a prescribed format, recognizes the ID and the attached data while associating them with each other,
said ID generating means being able to generate the ID associated with the attached data recognized by the recognizing means.

43. An Internet access device comprising:
a real data generating means for generating real data representing image, voice/sound or the like corresponding to an ID representing attached data representing image, voice/sound or the like included in multimedia data;
a real data acquiring means for acquiring real data corresponding to the ID from a specific server or a server designated by a URL when the real data generating means cannot generate the real data corresponding to the ID; and
a reproducing means for reproducing the real data.

44. A recording medium containing a program for making computers function as the electronic mail creating means, the ID generating means and the real data generating means of the electronic mail transmission/reception system of claim 1.

45. A recording medium containing a program for making computers function as at least the electronic mail creating means and the ID generating means of the electronic mail transmission/reception system of claim 12.

46. A recording medium containing a program for making computers function as at least the electronic mail creating means, the ID generating means, the real data generating means of the electronic mail transmission/reception system of claim 22.

47. A recording medium containing a program for making a computer function as at least the electronic mail creating means and the ID generating means of the electronic mail creating/sending device of claim 31.

48. A recording medium containing a program for making a computer function as t he real data generating means of the electronic mail receiving/reproducing device of claim 36.

49. A recording medium containing a program for making a computer function as at least the electronic mail creating means, the ID generating means, and the real data generating means of the electronic mail transmission/reception device of claim 41.

50. A recording medium containing a program for making a computer function as at least the real data generating means, the real data acquiring means and the reproducing means of the Internet access device of claim 43.
